(19) United States
(12) Patent Application Publication
(10) Pub. No.: US 2024/0006630 A1
(43) Pub. Date: Jan. 4, 2024

(54) FLUID-CONDUCTING MODULE FOR A FUEL CELL DEVICE, FUEL CELL DEVICE, AND METHOD FOR PRODUCING A FLUID-CONDUCTING MODULE FOR A FUEL CELL DEVICE

(71) Applicant: EKPO Fuel Cell Technologies GmbH, Dettingen (DE)

(72) Inventors: Fabian LEUPOLZ, Tübingen (DE); Wadim KAISER, Reutlingen (DE); Stefan HEMMER, Metzingen (DE); Uwe PASERA, Esslingen (DE)

(73) Assignee: EKPO Fuel Cell Technologies GmbH, Dettingen (DE)

(21) Appl. No.: 18/465,374

(22) Filed: Sep. 12, 2023

Related U.S. Application Data
(63) Continuation of application No. PCT/EP2022/056351, filed on Mar. 11, 2022.

(30) Foreign Application Priority Data
Mar. 12, 2021 (DE) 10 2021 202 417.3

(51) Int. Cl. H01M 8/04007; H01M 8/04029; H01M 8/04089

(52) U.S. Cl. CPC H01M 8/04074; H01M 8/04029; H01M 8/04089

(57) ABSTRACT

The aim of the invention is to provide a fluid-conducting module for a fuel cell device, said fluid-conducting module being simple and inexpensive to produce and being used to operate a fuel cell device in a preferably efficient manner. According to the invention, this is achieved in that the fluid-conducting module comprises the following: a flow channel which comprises at least one flow channel inlet and at least one flow channel outlet and through which a first fluid, in particular a liquid, can be conducted; a heat exchanger, by means of which a second fluid, in particular a gas, can be heated, preferably by transferring heat from the first fluid to the second fluid.

### CROSS-REFERENCE TO RELATED APPLICATIONS

This application is a continuation of International Application No. PCT/EP2022/056351 filed on Mar. 11, 2022, and claims priority to German Application No. 10 2021 202 417.3 filed on Mar. 12, 2021, all of which are incorporated herein by reference in their entirety and for all purposes.

### FIELD OF DISCLOSURE AND BACKGROUND

The present invention relates to a fluid-conducting module for a fuel cell device.

The present invention is based on the object of providing a fluid-conducting module for a fuel cell device which is simple and inexpensive to produce and is used to operate a fuel cell device in a preferably efficient manner.

### SUMMARY OF THE INVENTION

According to the invention, this object is achieved by a fluid-conducting module for a fuel cell device having the features of claim 1.

Preferably, the fluid-conducting module comprises the following:
a flow channel which comprises at least one flow channel inlet and at least one flow channel outlet and through which a first fluid, in particular a liquid, can be conducted;
a heat exchanger, by means of which a second fluid, in particular a gas, can be heated, preferably by transferring heat from the first fluid to the second fluid.

The term “in particular” is preferably used in the context of this description and the appended claims to describe optional features.

The first fluid is preferably a temperature control fluid.

It may be advantageous if the first fluid is a cooling fluid, for example a water glycol mixture.

In particular, the first fluid is a temperature control fluid which is conducted through a fuel cell stack of the fuel cell device for temperature control of a fuel cell device.

The second fluid preferably comprises fuel, for example hydrogen, and/or anode gas, which is supplied to a fuel cell stack of the fuel cell device, for example.

The heat exchanger is preferably designed to transfer heat from the first fluid to the second fluid.

In particular, the fluid-conducting module is used to conduct a first fluid exiting one or more fuel cell stacks of a fuel cell device.

For example, it is conceivable that the fluid-conducting module is designed in such a manner that only the first fluid exiting from a single fuel cell stack of a fuel cell device is conducted in the flow channel of the fluid-conducting module.

Alternatively, it is conceivable that the fluid-conducting module is designed in such a manner that the first fluid exiting from a plurality of, for example two, fuel cell stacks of a fuel cell device is conducted in the flow channel of the fluid-conducting module.

In particular, the fluid-conducting module is designed in such a manner that the first fluid exiting from a plurality of fuel cell stacks of a fuel cell device is combined.

In particular, the first fluid can be conducted from the at least one flow channel inlet of the flow channel to the at least one flow channel outlet of the flow channel.

For example, it is conceivable that the flow channel comprises two flow channel inlets and a flow channel outlet, wherein the flow channel preferably comprises two inlet sections and one outlet section.

The flow channel preferably comprises a combining portion at which the two inlet portions of the flow channel are combined and which is preferably arranged between the two inlet portions and the outlet portion in the flow direction.

In one embodiment of the fluid-conducting module, it is provided that the heat exchanger comprises a heat exchanger inlet and a heat exchanger outlet, wherein the second fluid can preferably be conducted through one or more heat exchanger channels from the heat exchanger inlet to the heat exchanger outlet, in particular through one or more first heat exchanger channels, and/or wherein the first fluid can preferably be conducted through one or more heat exchanger channels, in particular through one or more second heat exchanger channels.

For example, it is conceivable that the heat exchanger comprises a heat exchanger base body.

The heat exchanger base body comprises, for example, a metallic material or is formed therefrom.

The heat exchanger comprises, for example, a heat exchanger inlet element and a heat exchanger outlet element.

The heat exchanger inlet element preferably comprises the heat exchanger inlet, wherein the heat exchanger outlet element preferably comprises the heat exchanger outlet.

It is conceivable, for example, for the heat exchanger inlet element and the heat exchanger outlet element to comprise a metallic material or being formed therefrom.

It may be advantageous if the heat exchanger is fixed to a fluid-conducting module base body of the fluid-conducting module.

The heat exchanger is, for example, screwed to the fluid-conducting module base body.

For example, it is conceivable for the heat exchanger inlet element and the heat exchanger outlet element to be passed through passage openings in the fluid-conducting module base body and, for example, each to be fixed to the fluid-conducting module base body by means of a nut element.

In one embodiment of the fluid-conducting module, it is provided that the fluid-conducting module comprises a fluid-supplying port, by means of which the second fluid can be supplied to the fluid-conducting module, and that the fluid-conducting module comprises a fluid-discharging port, by means of which the second fluid can be discharged from the fluid-conducting module.

It may be advantageous if the fluid-supplying port is fluidically connected to the heat exchanger inlet and/or if the fluid-discharging port is fluidically connected to the heat exchanger outlet.

Preferably, the fluid-conducting module comprises a fluid-supplying port element which comprises or forms the fluid-supplying port.

Preferably, the fluid-conducting module comprises a fluid-discharging port element which comprises or forms the fluid-discharging port.

In an embodiment of the fluid-conducting module, it is provided that the fluid-supplying port is electrically insulated from the heat exchanger, in particular from the heat exchanger inlet of the heat exchanger, and/or that the fluid-discharging port is electrically insulated from the heat exchanger, in particular from the heat exchanger outlet of the heat exchanger.

In an embodiment of the fluid-conducting module, it is provided that the fluid-conducting module comprises one or more insulating elements, wherein a respective insulating element fluidically connects the fluid-supplying port of the fluid-conducting module to the heat exchanger inlet of the heat exchanger and/or wherein a respective insulating element fluidically connects the fluid-discharging port of the fluid-conducting module to the heat exchanger outlet of the heat exchanger.

For example, it is conceivable for the fluid-conducting module to comprise a single or one-piece insulating element, wherein, on the one hand, the single or one-piece insulating element fluidically connects the fluid-supplying port of the fluid-conducting module to the heat exchanger inlet of the heat exchanger, and, on the other hand, the one-piece insulating element fluidically connects the fluid-discharging port of the fluid-conducting module to the heat exchanger outlet of the heat exchanger.

Alternatively, it is conceivable that the fluid-conducting module comprises two insulating elements, wherein a first insulating element fluidically connects the fluid-supplying port of the fluid-conducting module to the heat exchanger inlet of the heat exchanger and wherein a second insulating element fluidically connects the fluid-discharging connection of the fluid-conducting module to the heat exchanger outlet of the heat exchanger.

It may be advantageous if an insulating element is arranged between a heat exchanger inlet element and a fluid-supplying port element.

It may further be advantageous if an insulating element is arranged between a heat exchanger outlet element and a fluid-discharging port element.

In one embodiment of the fluid-conducting module, it is provided that a respective insulating element comprises a connecting portion and a covering portion, wherein a connecting portion of an insulating element preferably fluidically connects a heat exchanger inlet element to a fluid-supplying port element and a covering portion of the insulating element preferably covers the heat exchanger inlet element and/or wherein a connecting portion of an insulating element preferably fluidically connects a heat exchanger outlet element to a fluid-discharging port element and a covering portion of the insulating element preferably covers the heat exchanger outlet element.

For example, a covering portion of an insulating element completely covers the heat exchanger inlet element and/or the heat exchanger outlet element with respect to an environment of the fluid conducting module.

A surface of the covering portion of an insulating element preferably forms a portion of an outer surface of the fluid-conducting module.

In one embodiment of the fluid-conducting module, it is provided that the one or more insulating elements comprise or are formed from an electrical insulating material, for example a plastic material.

The one or more insulating elements are preferably plastic components, for example plastic injection-molded components.

It may be advantageous if the fluid-conducting module is designed such that, in the region of a fluid-supplying port and/or in the region of a fluid-discharging port, the fluid-conducting module has a breakdown voltage of at least approximately 1 kV, for example of at least approximately 10 kV, preferably of at least approximately 100 kV.

Preferably, the fluid-conducting module and/or elements of the fluid-conducting module are designed such that, in the region of a fluid-supplying port and/or in the region of a fluid-supplying port, the fluid-conducting module has a breakdown voltage of at least approximately 1 kV, for example of at least approximately 10 kV, preferably of at least approximately 100 kV.

For example, it is conceivable that a material of a fluid-conducting module base body and/or a material of one or more elements of the fluid-conducting module are designed such that, in the region of a fluid-supplying port and/or in the region of a fluid-discharging port, the fluid-conducting module has a breakdown voltage of at least approximately 1 kV, for example of at least approximately 10 kV, preferably of at least approximately 100 kV.

It may further be advantageous if a component geometry of a fluid-conducting module base body and/or a component geometry of one or more elements of the fluid-conducting module are designed such that, in the region of a fluid-supplying port and/or in the region of a fluid-discharging port, the fluid-conducting module has a breakdown voltage of at least approximately 1 kV, for example of at least approximately 10 kV, preferably of at least approximately 100 kV.

For example, it is conceivable that a respective insulating element of the fluid-conducting module is designed such that a breakdown voltage in the region of a fluid-supplying port and/or in the region of a fluid-discharging port is at least approximately 1 kV, for example of at least approximately 10 kV, preferably of at least approximately 100 kV.

A material of a respective insulating element is preferably designed such that a breakdown voltage in the region of a fluid-supplying port and/or in the region of a fluid-discharging port is at least approximately 1 kV, for example of at least approximately 10 kV, preferably of at least approximately 100 kV.

Preferably, a component geometry of a respective insulating element, for example a material thickness of the respective insulating element, is designed such that a breakdown voltage in the region of a fluid-supplying port and/or in the region of a fluid-discharging port is at least approximately 1 kV, for example of at least approximately 10 kV, preferably of at least approximately 100 kV.

In one embodiment of the fluid-conducting module, it is provided that the heat exchanger is arranged and/or designed such that heat is transferred from the first fluid to the second fluid.

The heat exchanger is, for example, a cross-flow heat exchanger.

It may be advantageous if a first fluid flow of the first fluid can be conducted through the heat exchanger in a first direction.

It may further be advantageous if a second fluid flow of the second fluid can be conducted through the heat exchanger in a second direction, the first direction preferably being substantially perpendicular to the second direction.

In one embodiment of the fluid-conducting module, it is provided that the heat exchanger is arranged at least partially in the flow channel of the fluid-conducting module and/or at least partially projects into the flow channel of the fluid-conducting module.

It may be particularly advantageous if a heat exchanger base body of the heat exchanger is arranged completely within the flow channel of the fluid-conducting module.

In one embodiment of the fluid-conducting module, it is provided that the fluid-conducting module or the flow channel of the fluid-conducting module comprises a bypass channel, by means of which at least a portion of the first fluid can be conducted from the at least one flow channel inlet of the flow channel to the at least one flow channel outlet of the flow channel while bypassing the heat exchanger.

The bypass channel is preferably designed such that the first fluid can be conducted at least partially past the heat exchanger.

In particular, the bypass channel is formed by a remaining free cross-section of the flow channel.

A cross-section of the flow channel, taken perpendicular to the flow direction, is preferably only partially filled by the heat exchanger.

A cross-section of the flow channel taken in a cross-sectional plane arranged perpendicular to a main flow direction is preferably larger than a cross-section of the heat exchanger taken in the cross-sectional plane.

A cross-section of the bypass channel taken in a cross-sectional plane arranged perpendicular to a main flow direction preferably corresponds to a difference of a cross-section of the flow channel taken in the cross-sectional plane and a cross-section of the heat exchanger taken in the cross-sectional plane.

In one embodiment of the fluid-conducting module, it is provided that the fluid-conducting module and/or the heat exchanger are designed such that a partial flow of the first fluid flowing through the heat exchanger is at least approximately 5%, preferably at least approximately 10%, of a total flow of the first fluid flowing through the flow channel of the fluid-conducting module.

For example, it is conceivable that the fluid-conducting module and/or the heat exchanger are designed such that a partial flow of the first fluid flowing through the heat exchanger is approximately 50% of a total flow of the first fluid flowing through the flow channel of the fluid-conducting module.

The bypass channel is preferably designed such that at least approximately 10%, preferably at least approximately 20%, for example at least approximately 30%, of the first fluid flowing through the flow channel can be conducted past the heat exchanger.

It may be advantageous if the bypass channel is designed such that at most approximately 90%, preferably at most approximately 80%, for example at most approximately 70%, of the first fluid flowing through the flow channel can be conducted past the heat exchanger.

In one embodiment of the fluid-conducting module, it is provided that the fluid-conducting module comprises one or more fluid-conducting elements arranged in the flow channel, wherein first fluid flowing through the flow channel can preferably be conducted to the heat exchanger by means of one or more fluid-conducting elements and/or wherein first fluid flowing through the flow channel can preferably be conducted past the heat exchanger by means of one or more fluid-conducting elements.

The fluid-conducting elements are preferably integrally formed with a fluid-conducting module base body of the fluid-conducting module.

A respective fluid conducting element is, for example, a flow fin.

For example, it is conceivable for the fluid-conducting elements to be injection-molded onto the fluid-conducting module base body during production of the fluid-conducting module base body in an injection-molding process.

In one embodiment of the fluid-conducting module, it is provided that the fluid-conducting module comprises one or more adjustable fluid-conducting elements arranged in the flow channel, which are designed to be adjustable.

An orientation of an adjustable fluid-conducting element is preferably adjustable.

By adjusting an adjustable fluid-conducting element, a flow direction of the first fluid in the flow channel can preferably be influenced.

In particular, the first fluid can be actively conducted to the heat exchanger or to the bypass channel by adjusting an adjustable fluid-conducting element.

For example, it is conceivable that the fluid-conducting module comprises one or more drive motors, wherein, for example, an orientation of an adjustable fluid-conducting element can be adjusted in each case by means of a drive motor, for example by rotating the fluid-conducting element.

In one embodiment of the fluid-conducting module, it is provided that the heat exchanger comprises the following:
a heat exchanger base body; and/or
a heat exchanger inlet element; and/or
a heat exchanger outlet element; and/or
a first covering element, wherein the heat exchanger inlet element and the heat exchanger outlet element are arranged on the first covering element; and/or
a second covering element; and/or
a separating element.

It is conceivable, for example, that the heat exchanger base body, the heat exchanger inlet element, the heat exchanger outlet element, the covering elements and/or the separating element comprise a metallic material or are formed therefrom.

The first covering element and the second covering element are preferably arranged on sides of the heat exchanger base body facing away from one another.

The first covering element, the heat exchanger base body, the second covering element, the heat exchanger inlet element and/or the heat exchanger outlet element preferably delimit a flow path through which the second fluid can be conducted.

The first covering element, the heat exchanger base body, the second covering element, the heat exchanger inlet element and/or the heat exchanger outlet element are preferably connected to one another in a sealing manner.

The second covering element preferably forms a deflecting element by means of which the second fluid can be conducted from an inlet side of the heat exchanger to an outlet side of the heat exchanger.

It may be advantageous if the separating element separates the inlet side of the heat exchanger from the outlet side thereof.

The separating element is preferably arranged between the heat exchanger base body and the first covering element.

The heat exchanger base body comprises, for example, a plurality of wall elements which are preferably arranged at a distance from one another and/or parallel to one another.

Preferably, two wall elements of the heat exchanger base body each delimit first heat exchanger channels through which the second fluid can be conducted.

A respective wall element of the heat exchanger base body preferably further comprises a second heat exchanger channel through which the first fluid can be conducted.

The second heat exchanger channel is preferably arranged completely within a respective wall element of the heat exchanger base body.

A flow direction in the first heat exchanger channels is preferably substantially perpendicular to a flow direction in the second heat exchanger channels.

In one embodiment of the fluid-conducting module, it is provided that the fluid-conducting module comprises a fluid-conducting module base body and/or one or more cover elements.

The fluid-conducting module comprises, for example, a fluid-conducting module base body and two cover elements.

It can be advantageous if the two cover elements are arranged on sides of the fluid-conducting module base body facing away from one another.

For example, it is conceivable that a first cover element is arranged on a first side of the fluid-conducting module base body and that a second cover element is arranged on a second side of the fluid-conducting module base body.

The fluid-conducting module base body and/or the one or more cover elements preferably comprise a plastic material or are formed therefrom.

For example, it is conceivable that the fluid-conducting module base body and the one or more cover elements are injection-molded plastic components.

By means of a respective cover element of the fluid-conducting module, openings in the fluid-conducting module base body are preferably closed in a fluid-tight manner.

It may be advantageous if a respective cover element of the fluid-conducting module is connected by a material bond to the fluid-conducting module base body.

A respective cover element of the fluid-conducting module is preferably connected by a material bond to the fluid-conducting module base body on a circumferential edge surface of the respective cover element.

A circumferential edge surface of a first cover element is preferably arranged substantially parallel to a circumferential edge surface of a second cover element.

For example, it is conceivable that a respective cover element is bonded or welded to the fluid-conducting module base body, for example by plastic welding.

In an alternative embodiment of the fluid-conducting module, it may be provided that the heat exchanger comprises or forms a cover element of the fluid-conducting module, wherein by means of the cover element of the heat exchanger an opening in the fluid-conducting module base body is preferably closed, preferably in a fluid-tight manner.

An opening in the fluid-conducting module base body is preferably closed by means of a cover element of the heat exchanger in that the heat exchanger is inserted into the fluid-conducting module base body.

For example, it is conceivable that a cover element of the heat exchanger comprises a sealing element, for example a molded seal, for sealing between the cover element of the heat exchanger and the fluid-conducting module base body.

For example, it is conceivable that the fluid-conducting module base body comprises a respective flow channel inlet and/or the flow channel outlet of the flow channel.

It may be advantageous, for example, if two inlet portions of the flow channel are delimited by the fluid-conducting module base body and a first cover element.

It may further be advantageous if an opening through which the heat exchanger is inserted into the fluid-conducting module base body is closed by means of a second cover element.

The fluid-conducting module according to the invention is particularly suitable for use in a fuel cell device.

The present invention therefore relates to a fuel cell device comprising a fluid-conducting module according to the invention.

The fuel cell device according to the invention preferably has one or more of the features and/or advantages described in relation to the fluid-conducting module according to the invention.

Furthermore, the fluid-conducting module according to the invention preferably has one or more of the features and/or advantages described in relation to the fuel cell device according to the invention.

Preferably, the fuel cell device comprises one or more fuel cell stacks.

It may be advantageous for the fuel cell device to comprise a plurality of fuel cell stacks, such as two, three, four or more than four fuel cell stacks.

A number of the fuel cell stacks of the fuel cell device preferably corresponds to a number of the flow channel inlets of the fluid-conducting module.

It may be advantageous if a respective flow channel inlet of the fluid-conducting module is fluidically connected to a temperature control fluid outlet of a fuel cell stack of the fuel cell device, in particular with a so-called “manifold” of the fuel cell stack.

For example, the fuel cell device comprises two fuel cell stacks, wherein the temperature control fluid outlets of the two fuel cell stacks are each connected to a flow channel inlet of the fluid-conducting module.

Preferably, a respective temperature control fluid outlet of a fuel cell stack of the fuel cell device is connected to a respective flow channel inlet of the fluid-conducting module such that temperature control fluid flows from the fuel cell stack through the flow channel of the fluid-conducting module.

For example, it is conceivable for the fluid-conducting module to be fixed or fixable to a housing element of the fuel cell device.

The present invention is based on the further object of providing a method for producing a fluid-conducting module for a fuel cell device, by means of which a fluid-conducting module, with which a fuel cell device can preferably be operated efficiently, can be produced simply and inexpensively.

According to the invention, this object is achieved by a method for producing a fluid-conducting module for a fuel cell device having the features of claim 17.

The method for producing a fluid-conducting module for a fuel cell device is preferably used for producing a fluid-conducting module according to the invention.

Preferably, the method for producing a fluid-conducting module comprises the following:
providing a fluid-conducting module base body;
providing a heat exchanger;
inserting the heat exchanger into the fluid-conducting module base body through an opening of the fluid-conducting module base body;
closing the opening of the fluid-conducting module base body by means of a cover element.

The method for producing a fluid-conducting module according to the invention preferably has one or more of the features and/or advantages described in relation to the fluid-conducting module according to the invention and/or the fuel cell device according to the invention.

The fluid-conducting module according to the invention and/or the fuel cell device according to the invention preferably further have one or more of the features and/or advantages described in relation to the method for producing a fluid-conducting module according to the invention.

It may be advantageous if the heat exchanger is fixed, for example screwed, to the fluid-conducting module base body after the latter has been inserted into the fluid-conducting module base body and before the opening is closed.

The fluid-conducting module base body and the cover element are preferably produced by means of an injection molding process.

For closing the opening of the fluid-conducting module base body, the cover element is preferably connected by a material bond, for example bonded or welded, at a circumferential edge surface of the cover element to the fluid-conducting module base body.

Alternatively, it may be provided that the heat exchanger comprises or forms a cover element of the fluid-conducting module, wherein by means of the cover element of the heat exchanger an opening in the fluid-conducting module base body is preferably closed, preferably in a fluid-tight manner.

An opening in the fluid-conducting module base body is preferably closed by means of a cover element of the heat exchanger in that the heat exchanger is inserted into the fluid-conducting module base body.

Further preferred features and/or advantages of the invention form the subject-matter of the following description and the drawings illustrating embodiments.

### BRIEF DESCRIPTION OF THE DRAWINGS

FIG. 1 shows a schematic perspective representation of an embodiment of a fluid-conducting module for a fuel cell device from above;

FIG. 2 shows a schematic perspective representation of the embodiment of the fluid-conducting module embodiment of FIG. 1 from below;

FIG. 3 shows a representation of the embodiment of a fluid-conducting module of FIG. 1 corresponding to the representation of FIG. 1, wherein a first cover element of the fluid-conducting module is not shown;

FIG. 4 shows a representation of the embodiment of a fluid-conducting module of FIG. 1 corresponding to the representation of FIG. 2, wherein a second cover element of the fluid-conducting module is not shown;

FIG. 5 shows a schematic perspective sectional representation of the embodiment of a fluid-conducting module of FIG. 1 from below;

FIG. 6 shows a schematic bottom view of the embodiment of a fluid-conducting module of FIG. 1 when viewed along the arrow 6 in FIG. 2; and

FIG. 7 shows a schematic section through the embodiment of a fluid-conducting module of FIG. 1 along the line VII-VII in FIG. 6.

The same or functionally equivalent elements are provided with the same reference signs in all figures.

### DETAILED DESCRIPTION OF THE DRAWINGS

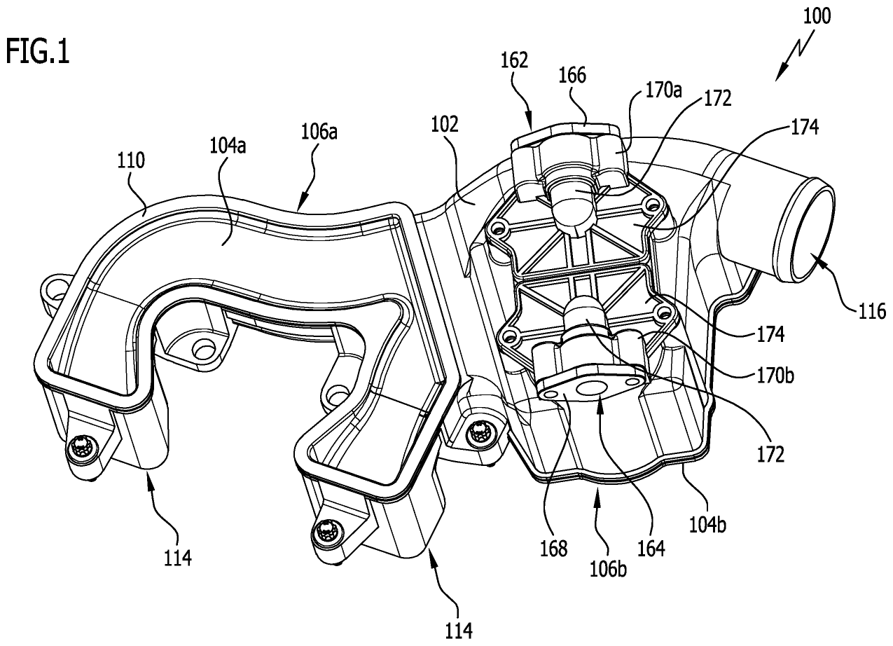

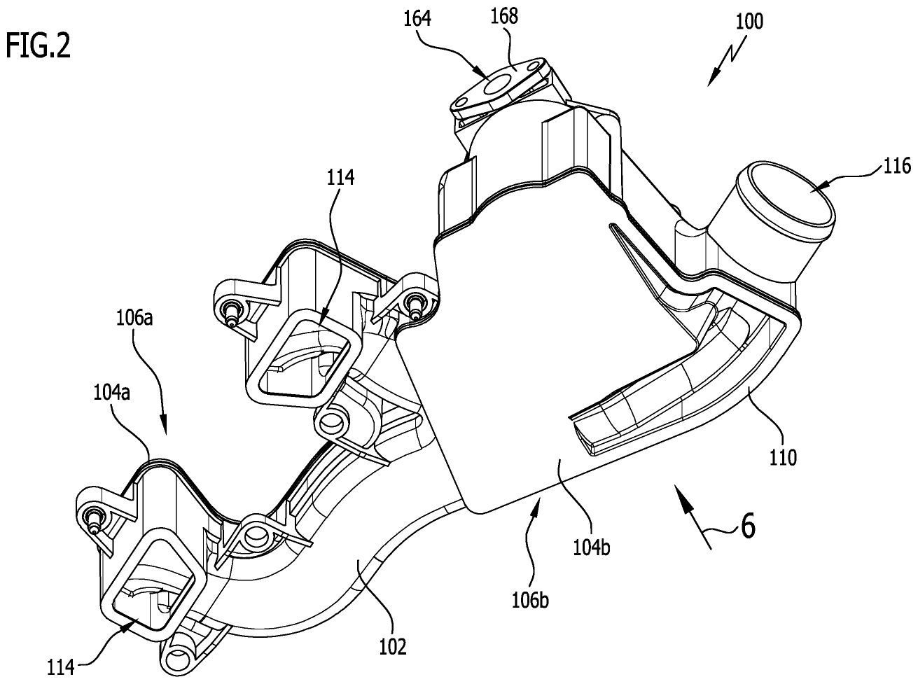

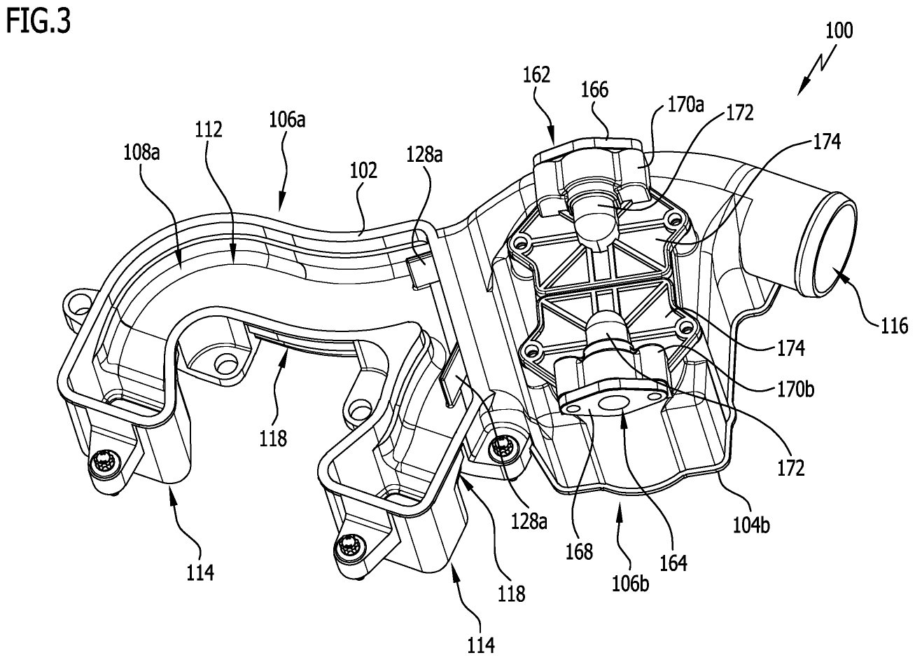

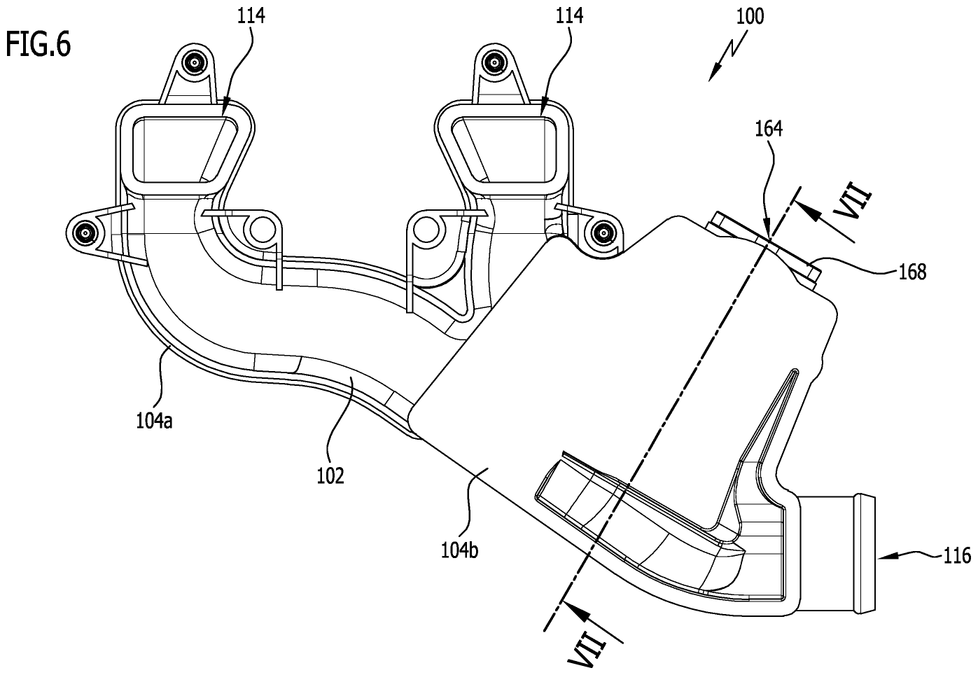

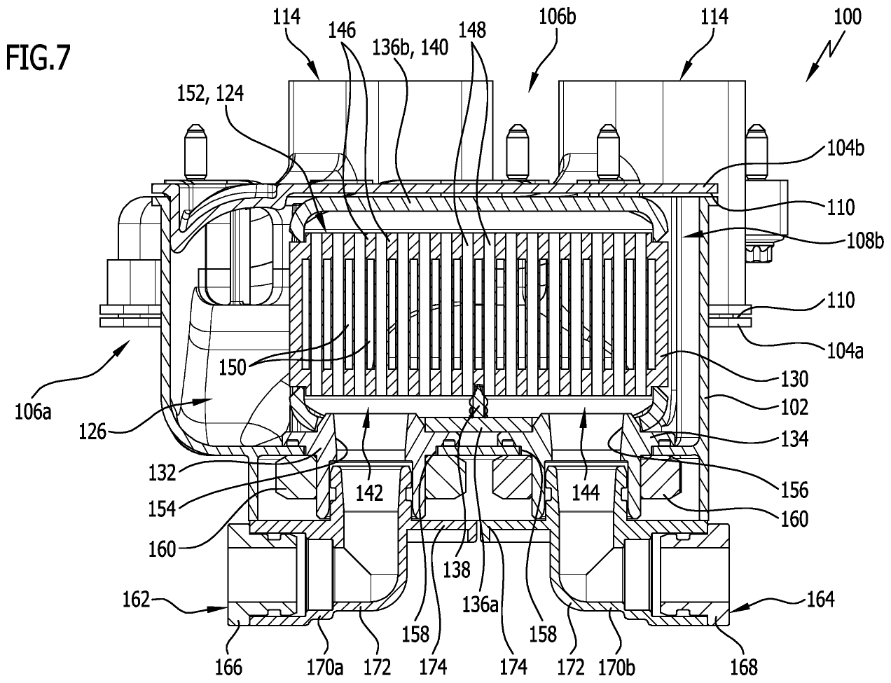

An embodiment of a fluid-conducting module for a fuel cell device not shown in the drawing, which is shown schematically in FIGS. 1 to 7 and is denoted as a whole by 100, preferably comprises a fluid-conducting module base body 102 and two cover elements 104.

The two cover elements 104 are preferably arranged on sides 106 of the fluid-conducting module base body 102 facing away from one another.

For example, it is conceivable that a first cover element 104 a is arranged on a first side 106a of the fluid-conducting module base body 102 and that a second cover element 104 is arranged on a second side 106b of the fluid-conducting module base body 102.

The fluid-conducting module base body 102 and the two cover elements 104 preferably comprise a plastic material or are formed therefrom.

The fluid-conducting module base body 102 and the two cover elements 104 are preferably injection-molded plastic components.

By means of a respective cover element 104 of the fluid-conducting module 100, openings 108 in the fluid-conducting module base body 102 are preferably closed in a fluid-tight manner.

The first cover element 104a preferably closes a first opening 108a on the first side 106a of the fluid-conducting module base body 102.

The second cover element 104b preferably closes a second opening 108b on the second side 106b of the fluid-conducting module base body 102.

The cover elements 104 of the fluid-conducting module 102 are preferably connected by a material bond to the fluid-conducting module base body 102, in particular on a circumferential edge surface 110 of a respective cover element 104.

The circumferential edge surface 110 of the first cover element 104a is preferably arranged substantially parallel to the circumferential edge surface 110 of the second cover element 104b.

The cover elements 104 are preferably bonded or welded to the fluid-conducting module base body 102, for example by plastic welding.

The fluid-conducting module 100 preferably comprises a flow channel 112.

The flow channel 112 preferably comprises two flow channel inlets 114 and a flow channel outlet 116.

A first fluid, in particular a liquid, can preferably be conducted through the flow channel 112 in a main flow direction 113, preferably from the two flow channel inlets 114 to the flow channel outlet 116.

The embodiment of a fluid-conducting module 100 shown in FIGS. 1 to 7 is used, in particular, to conduct a first fluid exiting from two fuel cell stacks of a fuel cell device not shown in the drawing.

The first fluid is preferably a temperature control fluid.

It may be advantageous if the first fluid is a cooling fluid, for example a water glycol mixture.

In particular, the first fluid is a temperature control fluid which is conducted through a fuel cell stack of the fuel cell device for temperature control of a fuel cell device.

In particular, the fluid-conducting module 100 is designed such that the first fluid exiting from two fuel cell stacks of a fuel cell device is conducted in the flow channel 112 of the fluid-conducting module 100.

The number of fuel cell stacks of the fuel cell device preferably corresponds to the number of flow channel inlets 114 of the fluid-conducting module 100.

It may be advantageous if a respective flow channel inlet 114 of the fluid-conducting module 100 is fluidically connected or connectable to a temperature control fluid outlet of a fuel cell stack of the fuel cell device not shown in the drawing, in particular with a so-called “manifold” of the fuel cell stack.

For example, the fuel cell device comprises two fuel cell stacks, wherein the temperature control fluid outlets of the two fuel cell stacks are each connected to a flow channel inlet 114 of the fluid-conducting module 100.

Preferably, a respective temperature control fluid outlet of a fuel cell stack of the fuel cell device is connected to a respective flow channel inlet 114 of the fluid-conducting module 100 such that temperature control fluid flows from the fuel cell stack through the flow channel 112 of the fluid conducting module 100.

For example, it is conceivable for the fluid-conducting module 100 to be fixed or fixable to a housing element of the fuel cell device.

The flow channel 112 preferably comprises two inlet portions 118 and one outlet portion 120.

The flow channel 112 preferably further comprises a combining portion 112 on which the two inlet portions 118 of the flow channel 112 are combined and which is preferably arranged between the two inlet portions 118 and the outlet portion 120 in the main flow direction 113.

The fluid-conducting module base body 102 of the fluid-conducting module 100 preferably comprises the flow channel inlets 114 and the flow channel outlet 116 of the flow channel 112.

The two inlet portions 118 of the flow channel 112 are preferably delimited by the fluid-conducting module base body 102 and the first cover element 104a.

The fluid-conducting module 100 preferably further comprises a heat exchanger 124 by means of which a second fluid, in particular a gas, can be heated, preferably by transferring heat from the first fluid to the second fluid.

The heat exchanger 124 is preferably designed to transfer heat from the first fluid to the second fluid.

The second fluid preferably comprises fuel, for example hydrogen, and/or anode gas, which is supplied to a fuel cell stack of a fuel cell device, for example.

The heat exchanger 124 is, for example, at least partially arranged in the flow channel 112 of the fluid-conducting module 100 and/or projects at least partially into the flow channel 112 of the fluid-conducting module 100.

Preferably, a heat exchanger base body of the heat exchanger 124 yet to be described is arranged completely within the flow channel 112 of the fluid-conducting module 100.

The heat exchanger 124 is preferably inserted through the second opening 108b into the fluid-conducting module base body 102 and fixed thereto.

Subsequently, the second opening 108b is preferably closed by means of the second cover element 104b.

For closing the second opening 108b of the fluid-conducting module base body 102, the second cover element 104b is preferably connected by a material bond, for example bonded or welded, at the circumferential edge surface 110 of the second cover element 104b to the fluid-conducting module base body 102.

In an embodiment of the fluid-conducting module 100, not shown in the drawing, it may be provided that the heat exchanger 124 comprises or forms a cover element 104 of the fluid-conducting module 100, wherein by means of the cover element 104 of the heat exchanger 124 an opening 108 in the fluid-conducting module base body 102 is preferably closed, preferably in a fluid-tight manner.

Here, the opening 108 in the fluid-conducting module base body 102 is preferably closed by means of the cover element 104 of the heat exchanger 124 in that the heat exchanger 124 is inserted into the fluid-conducting module base body 102.

For example, it is conceivable that the cover element 104 of the heat exchanger 124 comprises a sealing element, for example a molded seal, for sealing between the cover element 104 of the heat exchanger 124 and the fluid-conducting module base body 102.

The fluid-conducting module 100 or the flow channel 112 of the fluid-conducting module 100 preferably comprises a bypass channel 126, by means of which at least a portion of the first fluid can be conducted from the two flow channel inlets 114 of the flow channel 112 to the flow channel outlet 116 of the flow channel 112 while bypassing the heat exchanger 124.

The bypass channel 126 is preferably designed such that the first fluid can be conducted at least partially past the heat exchanger 124.

In particular, the bypass channel 126 is formed by a remaining free cross-section of the flow channel 112.

A cross-section of the flow channel 112, taken perpendicular to the main flow direction 113, is preferably only partially filled by the heat exchanger 124.

A cross-section of the flow channel 112 taken in a cross-sectional plane arranged perpendicular to the main flow direction 113 is preferably larger than a cross-section of the heat exchanger 124 taken in the cross-sectional plane.

A cross-section of the bypass channel 126 taken in a cross-sectional plane arranged perpendicular to the main flow direction 113 preferably corresponds to a difference of a cross-section of the flow channel 112 taken in the cross-sectional plane and a cross-section of the heat exchanger 124 taken in the cross-sectional plane.

It may be advantageous if the fluid-conducting module 100 and/or the heat exchanger 124 are designed such that a partial flow of the first fluid flowing through the heat exchanger 124, is at least approximately 5%, preferably at least approximately 10%, of a total flow of the first fluid flowing through the flow channel 112 of the fluid-conducting module 100.

For example, it is conceivable that the fluid-conducting module 100 and/or the heat exchanger 124 are designed such that a partial flow of the first fluid flowing through the heat exchanger 124 is approximately 50% of a total flow of the first fluid flowing through the flow channel 112 of the fluid-conducting module 100.

For example, the bypass channel 126 is designed such that at least approximately 10%, preferably at least approximately 20%, for example at least approximately 30%, of the first fluid flowing through the flow channel 112 can be conducted past the heat exchanger 124.

It may be advantageous if the bypass channel 126 is designed such that at most approximately 90%, preferably at most approximately 80%, for example at most approximately 70%, of the first fluid flowing through the flow channel 112 can be conducted past the heat exchanger 124.

In an embodiment of the fluid-conducting module 100 not shown in the drawings, it may be provided that the fluid-conducting module 100 and/or the heat exchanger 124 are designed such that up to 100% of a total volume flow of a first fluid flowing through the flow channel 112 of the fluid-conducting module 100 flows through the heat exchanger 124. Here, the fluid-conducting module 100 preferably does not comprise a bypass channel 112.

The fluid-conducting module 100 preferably comprises a plurality of fluid-conducting elements 128 arranged in the flow channel 112, wherein first fluid flowing through the flow channel 112 can preferably be conducted to the heat exchanger 124 by means of a first fluid-conducting element 128a and wherein first fluid flowing through the flow channel 112 can preferably be conducted past the heat exchanger 124 by means of a plurality of second fluid-conducting elements 128b.

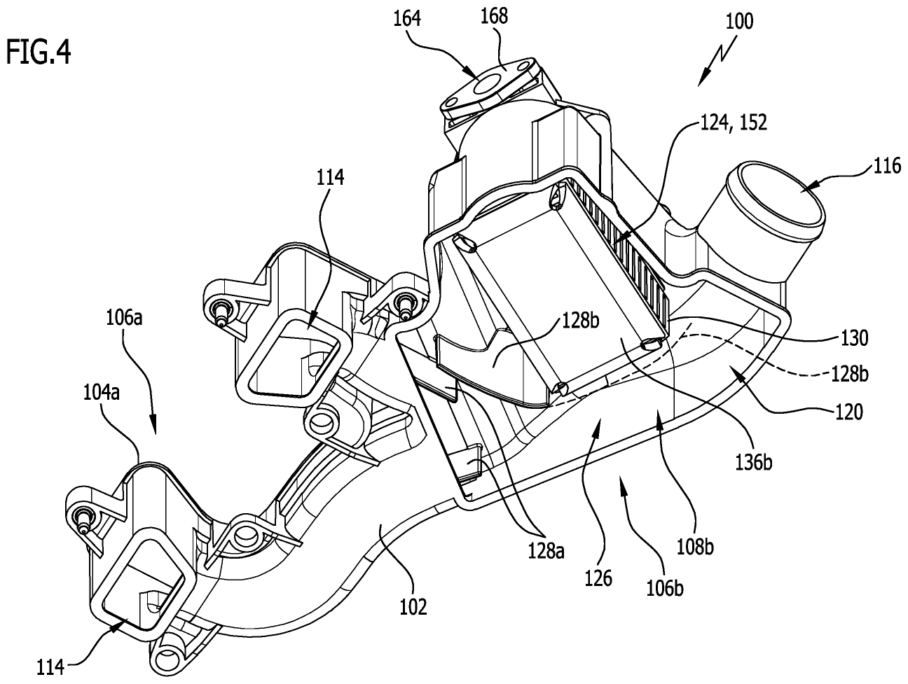

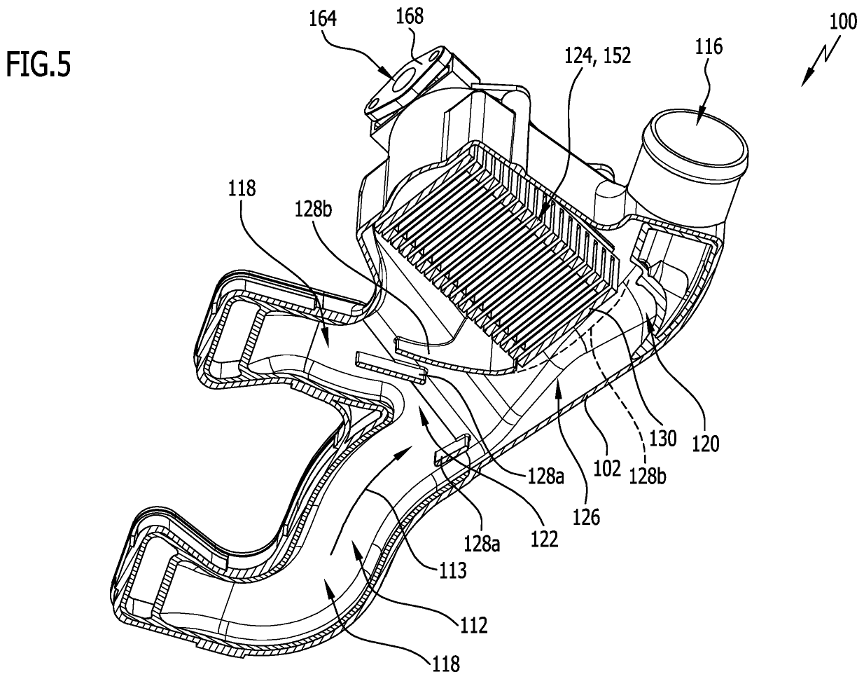

In FIGS. 4 and 5, the fluid-conducting element 128b is shown partially dashed and can, for example in the flow direction, extend completely along the heat exchanger 124.

The fluid-conducting elements 128 are preferably integrally formed with the fluid-conducting module base body 102 of the fluid-conducting module 100.

The fluid-conducting elements 128 are, for example, flow fins.

It may be advantageous if the fluid-conducting elements 128 are injection-molded onto the fluid-conducting module base body 102 in an injection-molding process during the production of the fluid-conducting module base body 102.

In an embodiment of the fluid-conducting module not shown in the drawing, it may be provided that the fluid-conducting module 100 comprises one or more adjustable fluid-conducting elements arranged in the flow channel 112, which are designed to be adjustable.

Here, an orientation of an adjustable fluid-conducting element is preferably adjustable.

By adjusting an adjustable fluid-conducting element, a flow direction of the first fluid in the flow channel 112 can preferably be influenced.

In particular, the first fluid can be actively conducted to the heat exchanger 124 or to the bypass channel 126 by adjusting an adjustable fluid-conducting element.

For example, it is conceivable that fluid-conducting module 100 comprises one or more drive motors, wherein, for example, an orientation of an adjustable fluid-conducting element can be adjusted in each case by means of a drive motor, for example by rotating the fluid-conducting element.

The heat exchanger 124 of the fluid-conducting module 100 preferably comprises a heat exchanger base body 130, a heat exchanger inlet element 132, a heat exchanger outlet element 134, a first covering element 136a, a second covering element 136b and/or a separating element 138.

The heat exchanger base body 130, the heat exchanger inlet element 132, the heat exchanger outlet element 134, the covering elements 136 and/or the separating element 138 preferably comprise a metallic material or are formed therefrom.

The first covering element 136a and the second covering element 136b are preferably arranged on sides of the heat exchanger base body 130 facing away from one another.

The first covering element 136a, the heat exchanger base body 130, the second covering element 136b, the heat exchanger inlet element 132 and/or the heat exchanger outlet element 134 preferably delimit a flow path through which the second Fluid can be conducted.

The first cover element 136a, the heat exchanger base body 130, the second cover element 136b, the heat exchanger inlet element 132 and/or the heat exchanger outlet element 134 are preferably connected to one another in a sealing manner.

The second covering element 136b preferably forms a deflecting element 140, by means of which the second fluid can be conducted from an inlet side 142 of the heat exchanger 124 to an outlet side 144 of the heat exchanger 124.

The separating element 138 is preferably arranged between the heat exchanger base body 130 and the first covering element 136a.

It may be advantageous if the separating element 138 separates the inlet side 142 of the heat exchanger 124 from the outlet side 144 thereof, in particular on the side of the first covering element 136.

Heat exchanger inlet element 132 and heat exchanger outlet element 134 are preferably arranged on the side of first covering element 136a and, in particular, connected thereto.

Heat exchanger inlet element 132 and heat exchanger outlet element 134 preferably project away from first covering element 136a of heat exchanger 124 and are preferably arranged substantially parallel to one another.

It may be advantageous if the heat exchanger base body 130 comprises a plurality of wall elements 146 which are preferably arranged at a distance from one another and/or parallel to one another.

Preferably, two wall elements 146 of the heat exchanger base body 130 each delimit first heat exchanger channels 148 through which the second fluid can be conducted.

The second fluid can preferably flow into the first heat exchanger channels 148 of the heat exchanger 124 via the heat exchanger inlet element 132 on the inlet side 142.

The second fluid preferably flows through the first heat exchanger channels 148 of the heat exchanger 124 on the inlet side 142 and is preferably deflected by means of the deflecting element 140 such that it flows on the outlet side 142 into the first heat exchanger channels 148 of the heat exchanger 124.

The second fluid can preferably flow out of the first heat exchanger channels 148 via the heat exchanger outlet element 134 on the outlet side 142.

The wall elements 146 of the heat exchanger base body 130 preferably further comprise a second heat exchanger channel 150 through which the first fluid can be conducted.

The second heat exchanger channels 150 are preferably each arranged completely within a wall element 146 of the heat exchanger base body 130.

A flow direction in the first heat exchanger channels 148 is preferably substantially perpendicular to a flow direction in the second heat exchanger channels 150.

Heat exchanger 124 is preferably a cross-flow heat exchanger 152.

Here, it may be advantageous if a first fluid flow of the first fluid can be conducted through the heat exchanger 124 in a first direction.

It may further be advantageous if a second fluid flow of the second fluid can be conducted through the heat exchanger 124 in a second direction, wherein the first direction preferably extends substantially perpendicular to the second direction.

The heat exchanger 124 preferably comprises a heat exchanger inlet 154 and a heat exchanger outlet 156, wherein the second fluid can preferably be conducted, through the first heat exchanger channels 148, from the heat exchanger inlet 154 to the heat exchanger outlet 156.

It may be advantageous if the heat exchanger inlet element 132 comprises the heat exchanger inlet 154, wherein the heat exchanger outlet element 134 preferably comprises the heat exchanger outlet 156.

The heat exchanger 124 is preferably fixed to the fluid-conducting module base body 102 of the fluid-conducting module 100, for example screwed to the fluid-conducting module base body 102.

For example, it is conceivable for the heat exchanger inlet element 132 and the heat exchanger outlet element 134 to be passed through openings 158 in the fluid-conducting module base body 102 and for example to be each fixed to the fluid-conducting module base body 102 by means of a nut element 160.

It may be advantageous if the fluid-conducting module 100 comprises a fluid-supplying port 162, by means of which the second fluid may be supplied to the fluid-conducting module 100.

The fluid-conducting module 100 preferably further comprises a fluid-discharging port 164, by means of which the second fluid can be discharged from the fluid-conducting module 100.

It may be advantageous if the fluid-supplying port 162 is fluidically connected to the heat exchanger inlet 154 and if the fluid-discharging port 164 is fluidically connected to the heat exchanger outlet 156.

The fluid-conducting module 100 preferably comprises a fluid-supplying port element 166 comprising or forming the fluid-supplying port 162.

The fluid-conducting module 100 preferably further comprises a fluid-discharging port element 168 comprising or forming the fluid-discharging port 164.

The fluid-supplying port 162 is preferably electrically insulated from the heat exchanger 124, in particular from the heat exchanger inlet 154 of the heat exchanger 124.

Preferably, the fluid-discharging port 164 is electrically insulated from the heat exchanger 124, in particular from the heat exchanger outlet 156 of the heat exchanger 124.

In particular, it may be advantageous if the housing 100 comprises two isolating elements 170.

A first insulating element 170a preferably fluidically connects the fluid-supplying port 162 of the fluid-conducting module 100 to the heat exchanger inlet 154 of the heat exchanger 124, wherein a second insulating element 170b preferably fluidically connects the fluid-discharging port 164 of the fluid-conducting module 100 to the heat exchanger outlet 156 of the heat exchanger 124.

The first insulating element 170a is in particular arranged between the heat exchanger inlet element 132 and the fluid-supplying port element 166.

It may further be advantageous if the second insulating element 170b is arranged between the heat exchanger outlet element 134 and the fluid-discharging port element 168.

The insulating elements 170 preferably each comprise a connecting portion 172 and a covering portion 174.

The connecting portion 172 of the first insulating element 170a preferably fluidically connects the heat exchanger inlet element 132 to the fluid-supplying port element 166.

It may be advantageous if the covering portion 174 of the first insulating element 170a completely covers the heat exchanger inlet element 132 with respect to an environment of the fluid-conducting module 100.

A surface of the covering portion 174 of the first insulating element 170a preferably forms a portion of an outer surface of the fluid-conducting module 100.

The connecting portion 172 of the second insulating element 170b preferably fluidically connects the heat exchanger outlet element 134 to the fluid-discharging port element 136.

It may be further advantageous if the covering portion 174 of the second insulating element 170b completely covers the heat exchanger outlet element 134 with respect to an environment of the fluid-conducting module 100

A surface of the covering portion 174 of the second insulating element 170b preferably forms a portion of an outer surface of the fluid-conducting module 100.

The insulating elements 170 preferably comprise or are formed from an electrical insulating material, such as a plastic material.

The insulation elements 170 are preferably plastic components, for example injection-molded plastic components.

The fluid-conducting module 100 is preferably designed such that, in the region of the fluid-supplying port 162 and/or in the region of the fluid-discharging port 164, the fluid-conducting module 100 has a breakdown voltage of at least approximately 1 kV, for example of at least approximately 10 kV, preferably of at least approximately 100 kV.

The fluid-conducting module 100 and/or elements of the fluid-conducting module 100 are preferably designed such that, in the region of the fluid-supplying port 162 and/or in the region of the fluid-discharging port 164, the fluid-conducting module 100 has a breakdown voltage of at least approximately 1 kV, for example of at least approximately kV, preferably of at least approximately 100 kV.

For example, it is conceivable that a material of the fluid-conducting module base body 102 and/or a material of one or more elements of the fluid-conducting module 100 are designed such that, in the region of the fluid-supplying port 162 and/or in the region of the fluid-discharging port 164, the fluid-conducting module 100 has a breakdown voltage of at least approximately 1 kV, for example of at least approximately 10 kV, preferably of at least approximately 100 kV.

It may further be advantageous if a component geometry of the fluid-conducting module base body 102 and/or a component geometry of one or more elements of the fluid-conducting module 100 are designed such that, in the region of the fluid-supplying port 162 and/or in the region of the fluid-discharging port 164, the fluid-conducting module 100 has a breakdown voltage of at least approximately 1 kV, for example of at least approximately 10 kV, preferably of at least approximately 100 kV.

For example, it is conceivable that the insulating elements 170 of the fluid-conducting module 100 are designed such that a breakdown voltage in the region fluid-supplying port 162 and/or in the region of the fluid-discharging port 164 is at least approximately 1 kV, for example of at least approximately 10 kV, preferably of at least approximately 100 kV.

A material of the insulating elements 170 is preferably designed such that a breakdown voltage in the region of the fluid-supplying port 162 and/or in the region of the fluid-discharging port 164 is at least approximately 1 kV, for example of at least approximately 10 kV, preferably of at least approximately 100 kV.

Preferably, a component geometry of the insulating elements 170, for example a material thickness of the insulating elements 170, is designed such that a breakdown voltage in the region of the fluid-supplying port 162 and/or in the region of the fluid-discharging port 164 is at least approximately 1 kV, for example of at least approximately 10 kV, preferably of at least approximately 100 kV.

Overall, a fluid-conducting module 100 for a fuel cell device can be provided, which is simple and cost-effective to produce and which is used to operate a fuel cell device in a preferably efficient manner.

1. A fluid-conducting module for a fuel cell device, wherein the fluid-conducting module comprises:
a flow channel which comprises at least one flow channel inlet and at least one flow channel outlet and through which a first fluid, in particular a liquid, can be conducted;
a heat exchanger, by means of which a second fluid, in particular a gas, can be heated, preferably by transferring heat from the first fluid to the second fluid.

2. The fluid-conducting module according to claim 1, wherein the heat exchanger comprises a heat exchanger inlet and a heat exchanger outlet, wherein the second fluid can preferably be conducted through one or more heat exchanger channels from the heat exchanger inlet to the heat exchanger outlet, in particular through one or more first heat exchanger channels, and/or wherein the first fluid can preferably be conducted through one or more heat exchanger channels, in particular through one or more second heat exchanger channels.

3. The fluid-conducting module according to claim 1, wherein the fluid-conducting module comprises a fluid-supplying port, by means of which the second fluid can be supplied to the fluid-conducting module, and wherein the fluid-conducting module comprises a fluid-discharging port by means of which the second fluid can be discharged from the fluid-conducting module.

4. The fluid-conducting module according to claim 2, wherein the fluid-supplying port is electrically insulated from the heat exchanger, in particular from the heat exchanger inlet of the heat exchanger, and/or wherein the fluid-discharging port is electrically insulated from the heat exchanger, in particular from the heat exchanger outlet of the heat exchanger.

5. The fluid-conducting module according to claim 2, wherein the fluid-conducting module comprises one or more insulating elements, wherein a respective insulating element fluidically connects the fluid-supplying port of the fluid-conducting module to the heat exchanger inlet of the heat exchanger, and/or wherein a respective insulating element fluidly connects the fluid-discharging port of the fluid-conducting module to the heat exchanger outlet of the heat exchanger.

6. The fluid-conducting module according to claim 5, wherein a respective insulating element comprises a connecting portion and a covering portion, wherein a connecting portion of an insulating element preferably fluidically connects a heat exchanger inlet element to a fluid-supplying port element, and a covering portion of the insulating element preferably covers the heat exchanger inlet element, and/or wherein a connecting portion of an insulating element preferably fluidically connects a heat exchanger outlet element to a fluid-discharging port element, and a covering portion of the insulating element preferably covers the heat exchanger outlet element.

7. The fluid-conducting module according to claim 5, wherein the one or more insulating elements comprise or are formed from an electrical insulation material, for example a plastic material.

8. The fluid-conducting module according to claim 1, wherein the heat exchanger is arranged and/or designed such that heat is transferred from the first fluid to the second fluid.

9. The fluid-conducting module according to claim 1, wherein the heat exchanger is arranged at least partially in the flow channel of the fluid-conducting module, and/or at least partially projects into the flow channel of the fluid-conducting module.

10. The fluid-conducting module according to claim 1, wherein the fluid-conducting module or the flow channel of the fluid-conducting module comprises a bypass channel, by means of which at least a portion of the first fluid can be conducted from the at least one flow channel inlet of the flow channel at least partially to the at least one flow channel outlet of the flow channel, while bypassing the heat exchanger.

11. The fluid-conducting module according to claim 10, wherein the fluid-conducting module and/or the heat exchanger are designed such that a partial flow of the first fluid flowing through the heat exchanger is at least approximately 5%, preferably at least approximately 10% of a total flow of the first fluid flowing through the flow channel of the fluid-conducting module.

12. The fluid-conducting module according to claim 1, wherein the fluid-conducting module comprises one or more fluid-conducting elements arranged in the flow channel, wherein first fluid flowing through the flow channel can preferably be conducted to the heat exchanger by means of one or more fluid-conducting elements, and/or wherein first fluid flowing through the flow channel can preferably be conducted past the heat exchanger by means of one or more fluid-conducting elements.

13. The fluid-conducting module according to claim 1, wherein the fluid-conducting module comprises one or more adjustable fluid-conducting elements arranged in the flow channel, which are designed to be adjustable.

14. The fluid-conducting module according to claim 1, wherein the heat exchanger comprises:
a heat exchanger base body; and/or
a heat exchanger inlet element; and/or
a heat exchanger outlet element; and/or
a first covering element, wherein the heat exchanger inlet element and the heat exchanger outlet element are arranged on the first covering element; and/or
a second covering element; and/or
a separating element.

15. The fluid-conducting module according to claim 1, according to the fluid-conducting module comprises a fluid-conducting module base body and/or one or more cover elements.

16. A fuel cell device comprising a fluid-conducting module according to claim 1.

17. A method for producing a fluid-conducting module for a fuel cell device, in particular for producing a fluid-conducting module according to claim 1, wherein the method comprises:
providing a fluid-conducting module base body;
providing a heat exchanger;
inserting the heat exchanger into the fluid-conducting module base body through an opening of the fluid-conducting module base body;
closing the opening of the fluid-conducting module base body by means of a cover element.
